(19) United States
(12) Patent Application Publication
(10) Pub. No.: US 2005/0265366 A1
(43) Pub. Date: Dec. 1, 2005

(54) Virtual private network system, communication terminal, and remote access communication method therefor

(75) Inventor: Satoru Ejiri, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/136,380

(22) Filed: May 25, 2005

(30) Foreign Application Priority Data
May 26, 2004 (JP) 155542/2004

(51) Int. Cl. H04L 12/66

(52) U.S. Cl. 370/401

(57) ABSTRACT

A method comprising performing an authentication between a communication terminal and a gateway via a first Internet protocol (IP) network according to a configuration method. Configuration data and an IP address belonging to a second IP network is issued from the gateway to the communication terminal. The second IP network is connected with the gateway.

This application is based upon and claims the benefit of priority from Japanese Patent Application No. 2004-155542, filed on May 26, 2004, the content of which is incorporated herein by reference.

### BACKGROUND

1. Technical Field

The disclosed teachings relate to a Virtual Private Network (VPN) system, border gateways, a communication terminal and a remote access communication method therefor. Specifically, the teachings relate to a remote access IP (Internet protocol) security protocol (IPsec) VPN to which Encapsulating Security Payload (ESP) tunneling of IPsec as an Internet Protocol (IP) tunneling technology applies.

2. Description of the Related Art

Japanese Patent Application Laid-Open No. 2002-208965 shows a IPsec VPN system. The remote access IPsec VPN, disclosed therein, employs an IP device specialized for a predetermined processing function as a remote terminal rather than a general-purpose personal computer (PC).

In the system disclosed therein, an address management server in the closed IP network issues the IP address belonging to the closed IP network to the remote terminal through an IP tunnel. This is because it is preferable to apply remote setting and management of a remote terminal's IP address belonging to a destination closed IP network with remote terminal access, in such a manner that the IP address is dynamically issued from a central station of the closed IP network. Further, the system automatically issues and sets remote terminal user configuration data. Still further the IP tunnel setting is updated automatically according to a dynamical change in a LAN IP address on each Local Area Network (LAN).

However, in general practice, even though a remote terminal authentication is provided, a remote terminal user authentication, and security of data that is exchanged by remote access communication need to be taken into consideration and the configuration data. Therefore, the configuration date and the IP address are set manually at the remote terminal.

### SUMMARY

For example, if a remote terminal in a IPsec VPN system is an IP device specialized for a predetermined processing function rather than a general-purpose PC, because the remote terminal is not always operated by a user, it is desirable to automatically set configuration data at the remote terminal for remote access.

One of objects of the disclosed teachings is to provide a VPN system, a communication terminal, and a remote access communication method that provide an automatic configuration for the communication terminal to access a remote network.

A method according to the disclosed technique comprises performing an authentication between a communication terminal and a gateway via a first IP (Internet protocol) network according to an ISAKMP (Internet key security association and key management protocol) configuration method, issuing configuration data and an IP address belonging to a second IP network from the gateway to the communication terminal, the second IP network being connected with the gateway.

### BRIEF DESCRIPTION OF THE DRAWINGS

These and other features, aspects, and advantages of the present technique will become better understood with reference to the following description, claims, and accompanying drawings, which should not be read to limit the technique in any way, in which:

FIG. 1 shows a VPN system according to an exemplary embodiment;

FIG. 2 shows a remote terminal in the VPN system according to an exemplary embodiment;

FIG. 3 show a border gateway in the VPN system according to an exemplary embodiment;

FIG. 4 shows an operation of the VPN system according to the exemplary embodiment of the present technique;

FIG. 5 (a) shows a data format of an ISAKMP packet that is used in the ISAKMP configuration method;

FIG. 5(b) shows a format of a configuration method payload;

FIG. 5(c) shows a format of Attributes;

FIG. 6 shows a VPN system according to the exemplary embodiment wherein the components are assigned concrete IP addresses; and

FIG. 7 shows a table listing parameters that may be set at a remote terminal and a BGW (2) 31 shown in FIG. 6.

### DETAILED DESCRIPTION

According to an exemplary embodiment of the disclosed techniques, a communication terminal performs an authentication with a gateway connected a IP network according to an ISAKMP (Internet key security association and key management protocol) configuration method. However, the authentication is performed between the communication terminal and the gateway via a secondary IP network.

The secondary network may be a public network. Furthermore, a pre-shared key may be used in the authentication. Subsequently to the authentication, the gateway issues a IP addressee that belongs to the IP network and configuration data to the communication terminal. Accordingly, the IP address and the configuration data can be set and updated for the communication terminal. Subsequent to that, the communication terminal accesses the remote IP network via the secondary IP network.

In addition, the communication terminal may establish an EPS (Encapsulating security payload) tunnel between the communication terminal and the gateway based on the issued IP address belonging to the IP network that the communication terminal remotely accesses. Accordingly, security of communication between the communication terminal and gateway can be ensured.

Exemplary embodiments of the techniques disclosed herein are described below with reference to the attached figures. The exemplary embodiments are intended to assist in the understanding of the teachings and are not intended to limit the scope of the invention in any way.

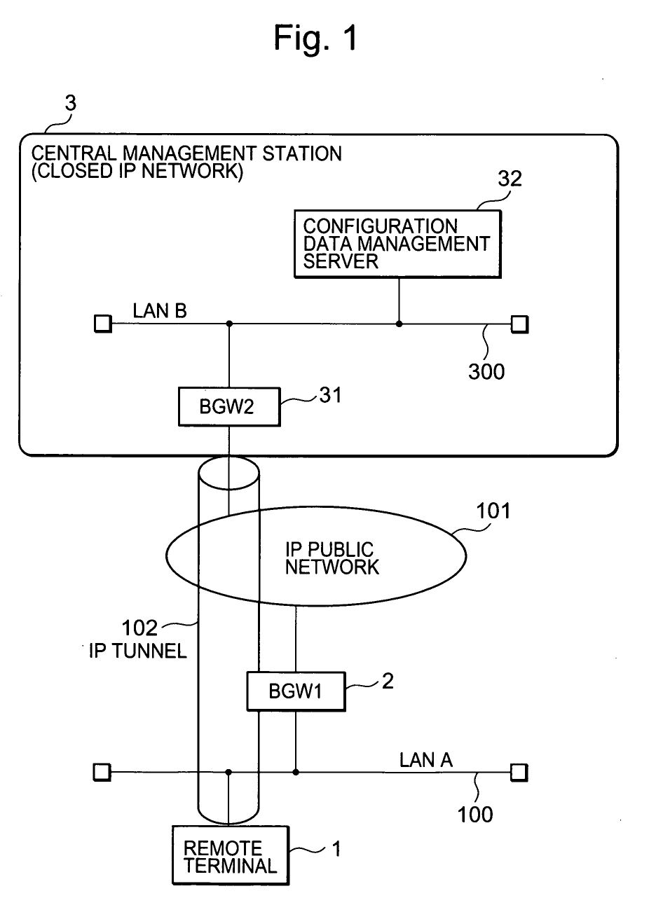

An exemplary embodiment will be described with reference to the drawings. FIG. 1 is a block diagram showing a Virtual Private Network (VPN) system according to the exemplary embodiment of the present technique. In FIG. 1, the VPN system is a remote access IP security protocol (IPsec) Virtual Private Network (VPN). Encapsulating Security Payload (ESP) tunneling of IPsec is provided based on an Internet Protocol (IP) tunneling technology.

The VPN system according to the exemplary embodiment comprises a remote terminal 1, a Border Gateway (BGW) (1) 2, a central management station 3, a local IP LAN (A) 100, and an IP public network 101, wherein an IP tunnel 102 may be set up between the remote terminal 1 and the central management station 3. The central management station 3 comprises a BGW (2) 31 and a configuration data management server 32, both of which are connected to a closed IP LAN (B) 300.

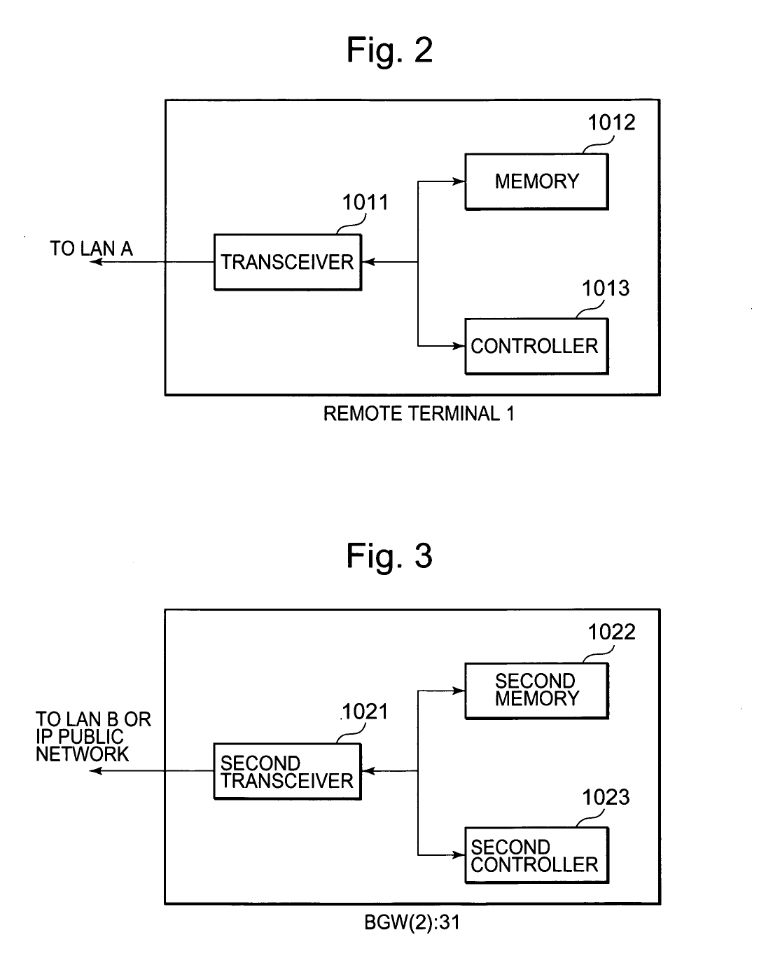

As shown in FIG. 2, the remote terminal 1 comprises a transceiver 1011, a memory 1012 and a controller 1013. The transceiver 1011 transmits signals to the LAN (A) 100 and revives signals from the LAN (A) 100. The controller 1013 is coupled to the transceiver 1011 and a memory 1012, and performs various operation with the BGW (2) 31, including authentication, establishing IPsec ESP tunnel, automatic IP address and configuration data setting and so on. The memory 1012 stores information used in the controller 1013's operations and stores the IP address and configuration data obtained by the controller 1013's operation.

As shown in FIG. 3, the BGW (2) comprises a second transceiver 1021, a second memory 1022 and a second controller 1023. The second transceiver 1021 transmits signals to the LAN (B) 300 and the IP public network 101. Further, the second transceiver 1021 revives signals from the LAN (B) 300 and the IP public network 101. The second controller 1023 is coupled to the second transceiver 1021 and the second memory 1022, and performs various operation with the remote terminal 1, such as authentication, establishing IPsec ESP tunnel starts, automatic IP address and configuration data setting and so on. The memory second 1022 stores information used in the controller 1023's operations.

Referring back to FIG. 1, the remote terminal 1 is connected to the local IP LAN (A) 100. The destination closed IP LAN (B) 300 which the remote terminal 1 access is relatively far away from the LAN (A) 100, wherein both the LANs are connected via the IP public network 101. Examples of such an IP public network are IP-VPN service, wide area Ethernet, etc. On each LAN and the IP public network 101, the BGW (1) 2 and BGW (2) 31 are respectively installed and interconnected.

In the remote access IPsec VPN system of the present technique, security of the closed IP LAN (B) 300 on which the configuration data management server 32 is installed is generally ensured, because this LAN is built within the central management station 3. However, since the IP public network 101 is an open network, a security problem (threat) needs to be avoided between the BGW (1) 2 and BGW (2) 31.

In the present exemplary embodiment, by issuing a unique IP address belonging to the closed IP LAN (B) 300 as a VPN address and issuing configuration data as private data using the ISAKMP configuration method, the IP address belonging to the closed IP LAN (B) 300 and configuration data can be dynamically issued to the remote terminal 1. In addition, security of the IP address belonging to the closed IP LAN (B) 300 and the configuration data can be ensured by using the encryption and authentication algorithms provided by IPsec.

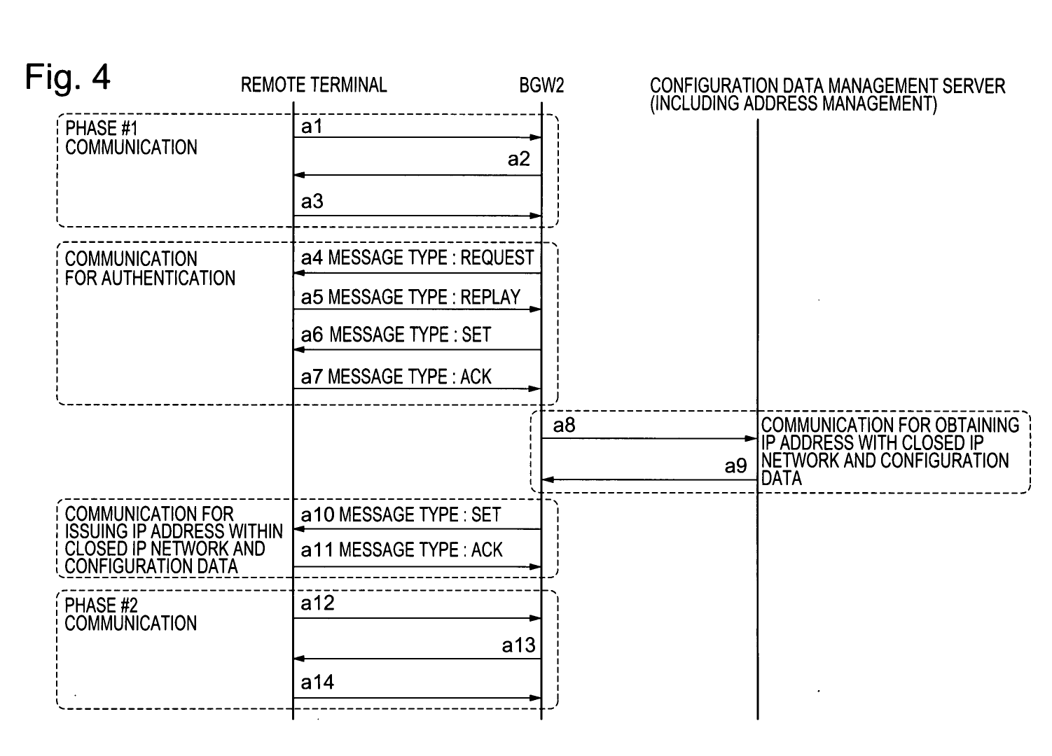

FIG. 4 shows a sequence chart describing the operation of the VPN system according to the exemplary embodiment of the present technique. FIG. 4 shows a sequence of messages between the remote terminal 1, BGW (2) 31, and configuration data management server 32 when remote access is set up. These messages together perform an IPsec VPN connection operation between the remote terminal 1 (as a remote host) and the BGW (2) 31. For communication of messages a10 and a11 in the connection operation, the Internet Security Association & Key Management Protocol (ISAKMP) configuration method is employed. Further, the remote terminal 1 (as a remote host) sets up an IPsec ESP tunnel mode from it to the BGW (2) 31 and eliminates any security threat.

The operation in which the remote terminal 1 establishes IPsec SA with the BGW (2) 31 in the central management station 3 is explained in reference to FIG. 4.

After establishing an Internet Key Exchange Security Association (IKE SA) communication in phase #1 communication (a1 to a3 in FIG. 4), a communication for authentication is performed through the IKE SA (a4 to a7 in FIG. 4). Subsequently, an IP address, which belongs to the destination closed IP LAN (B) 300, and configuration data are issued to the remote terminal 1 (a8 to a11 in FIG. 4). Therfore, in the present exemplary embodiment, automatic configuration of the remote terminal 1 is acheived.

Then, the IPsec SA connection is established through the phase #2 communication. This facilitates the starting of communication through the IPsec ESP.

In the operation described above, the BGW (2) 31 identifies the user of the remote terminal 1 by authenticating the user's identity at the user level of the remote terminal 1 (the user of the remote terminal 1, rather than the device thereof). The BGW (2) 31 then obtains the configuration data and the IP address belonging to the closed IP LAN (B) 300 from the configuration data management server 32 through a communication for obtaining configuration data.

The IP address belonging to the closed IP LAN (B) 300 to be issued to the remote terminal 1 is determined according to an addressing scheme for the closed IP LAN (B) 300. Thus, the BGW (2) 31 does not need to perform an address translation operation such as Network Address Translation (NAT) or the like, and the configuration data management server 32, BGW (2) 31, and remote terminal 1 can be treated as virtually connected in the same segment.

Because the remote terminal 1 (as a host) obtains the IPsec connection to the BGW (2) 31, using the IPsec's remote access connection function, the IP address for the local IP LAN (A) 100 can be dynamically assigned to the remote terminal 1 by Dynamic Host Configuration Protocol (DHCP) or the like.

After the phase #1 communication, the communication for authentication, and the communication for issuing configuration data and IP address belonging to the IP LAN (B) 300 are carried out through the above IKE SA, according to the IPsec's ISAKMP configuration method.

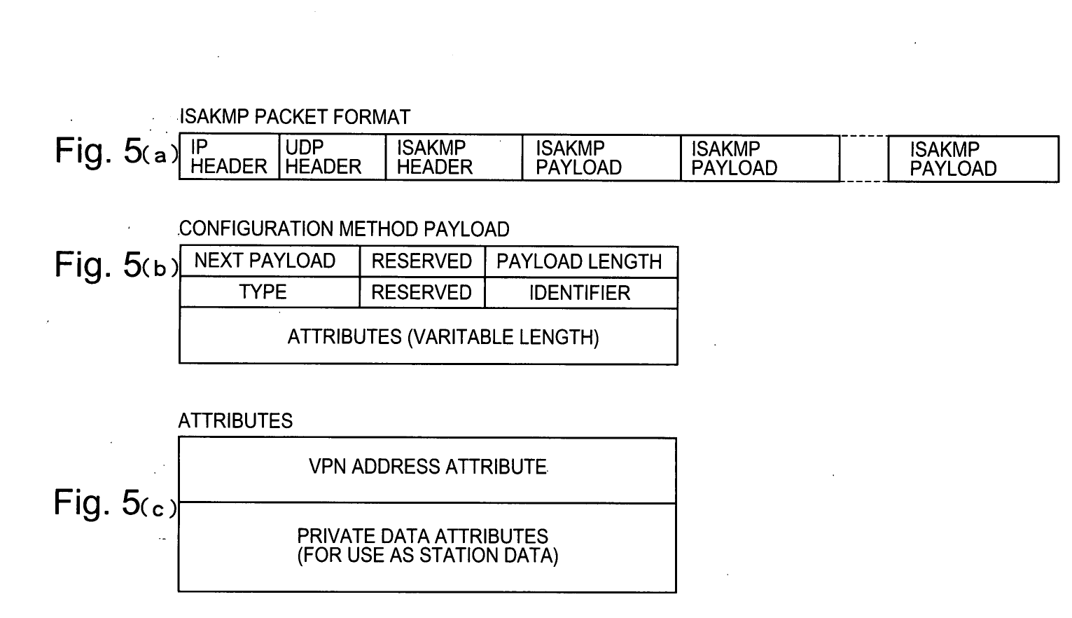

FIG. 5 (a) shows a data format of an ISAKMP packet that is used in the ISAKMP configuration method. ISAKMP packet may comprise IP header, UDP header, ISAKMP header, and ISAKMP payload. FIG. 5 (b) shows a formation of a configuration method payload that is used as an ISAKMP payload. The configuration method payload may comprise Attributes field, Payload length, Identifier and Type field.

In the case of the communication for authentication, authentication-related attributes are set in the Attributes field. In the case of the communication for issuing the configuration data, the IP address belonging to the IP LAN (B) 300, VPN address attribute and private data attributes are set in their fields as shown in FIG. 5 (c). Accordingly, the IP address belonging to the closed IP LAN (B) 300 and configuration data can be issued to the VPN address.

Similar to IKE communication, the ISAKMP configuration method is performed by an initiator that initiates message exchange and a responder that responds to the message sent by the initiator. In the present exemplary embodiment, the BGW (2) 31 is the initiator and the remote terminal 1 is the responder, and message exchange is performed therebetween. In the sequence shown in FIG. 4, each message type is identified by the value specified in the Type field of the configuration payload shown in FIG. 5 (b).

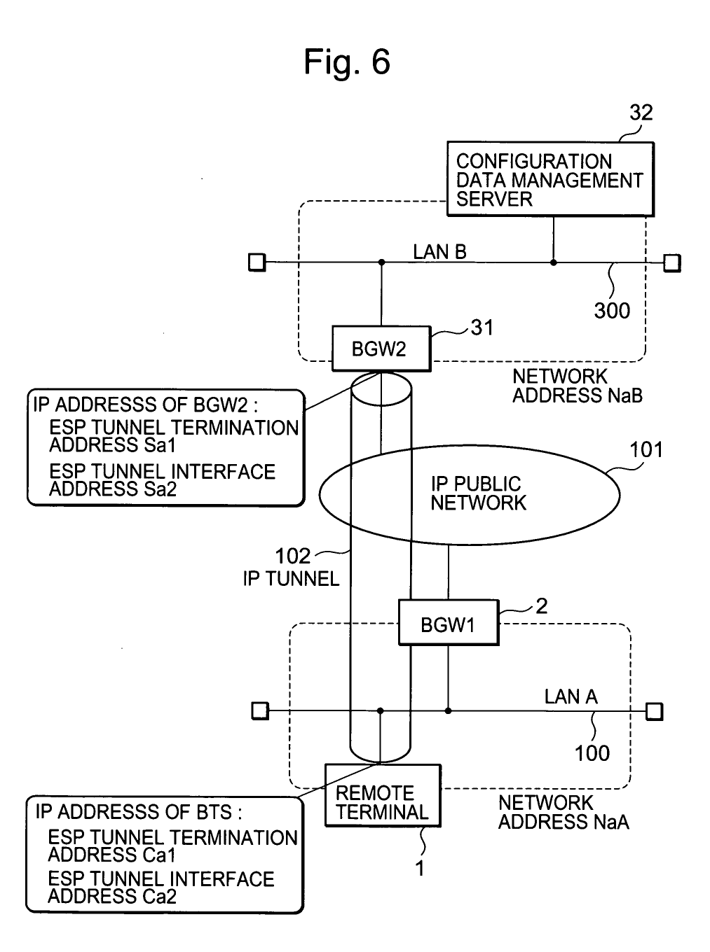

FIG. 6 is a diagram showing the system according to the exemplary embodiment wherein the components are assigned concrete IP addresses. In reference to FIGS. 4, 5 and 6, an operation of establishing Encapsulating Security Payload (ESP) tunnel of IPsec will be explained in detail.

In FIG. 6, to set up the Encapsulating Security Payload (ESP) tunnel of IPsec, addresses of the tunnel termination points and IP addresses of the tunnel interfaces that are used for IP communication through the tunnel are required.

The tunnel termination address and tunnel interface address' of the remote terminal 1 are assumed to be Ca1 and Ca2, respectively. The tunnel termination address and tunnel interface address of the BGW (2) 31 are assumed to be Sa1 and Sa2, respectively. A network address of the local IP LAN (A) 100 is assumed to be NaA and a network address of the closed IP LAN (B) 300 is assumed to be NaB.

IP address belonging to the closed IP LAN (B) 300 and configuration data to be issued to the remote terminal 1 are maintained by the configuration data management server 32, under the management of which the remote terminal 1 gets remote access.

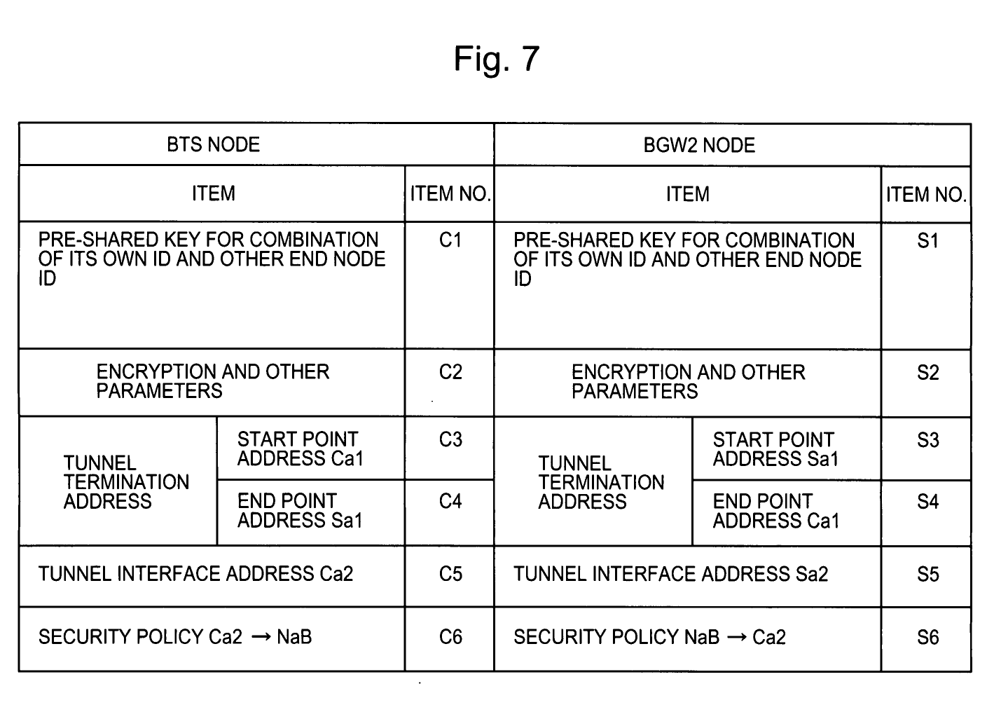

FIG. 7 shows parameters that must be set at the remote terminal 1 and the BGW (2) 31 to set up ESP tunnel of IPsec. In the present exemplary embodiment, because the phase #1 communication (a1 to a3) is performed in aggressive mode by applying the remote connection function, a Pre-Shared Key is identified by the IDs. Therefore, at the end nodes of the tunnel, a Pre-Shared Key for the combination of its own ID and the other end node ID must be registered, as described in item Nos. C1, S1.

In addition, the same values of parameters such as ESP encryption algorithm, Authentication Header (AH) algorithm, and Dynamic Host (DH) group must be registered at both nodes, as described in item Nos. C2, S2.

Parameters related to the tunnel, such as IP addresses of both the tunnel termination points (a start point address Ca1 and an end point address Sa1) (the item Nos. C3, and C4 in FIG. 7), and IP addresses of both the tunnel termination points (a start point address Sa1 and an end point address Ca1) (the item Nos. S3 and S4 in FIG. 7), must be registered.

Furthermore, IP address of a tunnel interface of its own node (Ca2, Sa2) must be registered (the item Nos. C5 and S5 in FIG. 7). To identify a packet that should be subjected to IPsec processing, security policy (Ca2->NaB, NaB->Ca2) must be registered (the item Nos. C6 and S6 in FIG. 7).

However, immediately after the start-up of the remote terminal 1, the parameters of item Nos. S3, S4, C5, C6, S6 are not registered.

After the start-up, “Ca1” is dynamically issued to the remote terminal 1 and the parameter of item No. S3 is registered. Then, a message a1 in the phase #1 communication is received by the BGW (2) 31 and the parameter of item No. S4 is registered.

In this regard, if in main mode, because the Pre-Shared Key is identified by both the tunnel termination addresses, the parameter of item No. S3 must be registered in advance. However, in aggressive mode, it is not necessary to register the parameter of item No. S3 in advance.

Next, the BGW (2) 31 identifies the user of the remote terminal 1 through the communication for authentication (a4 to a7) and sends' a query for the IP address belonging to the closed IP LAN (B) 300 and the configuration data to issued to the remote terminal 1, to the configuration data management server 32.

After obtaining the IP address and configuration data, the BGW (2) 31 issues the IP address and the configuration data to the remote terminal 1 through the communication for delivering configuration data (a10, a11). At this time, the IP address belonging to the closed IP LAN (B) 300 may be the tunnel interface address Ca2 of the remote terminal 1. Consequently, the parameters of item Nos. C5, C6 and S6 are registered. Because, the communication is through the ISAKMP SA so far, the communication can be performed normally without the tunnel interface address, namely, without the IP address belonging to the closed IP LAN (B) 300.

Subsequently, the IPsec SA connection is established through the phase #2 communication, and communication through the IPsec ESP tunnel starts. At this stage, all parameters listed in FIG. 7 are registered and, therefore, the communication can be performed normally.

As described above, in the present exemplary embodiment, while the security for the user of the remote terminal 1 is ensured, remote setting of the user configuration data can be performed.

Also, in the present exemplary embodiment, configuration data of the user of the remote terminal 1 and the IP address belonging to the closed IP LAN (B) 300 can be set automatically. Therefore, even when the IP address for the local IP LAN (A) 100 is changed dynamically, the IP tunnel setting can be automatically changed according to the change in the IP address. Accordingly, the number of man-hours required for setting work and rectifying errors can be reduced in comparison to manual configuration setting because plug & play of remote terminals can be performed.

Furthermore, in the present exemplary embodiment, the remote terminal 1, configuration data management server 32, BGW (1) 2, and BGW (2) 31 can be connected virtually in the same segment without providing the BGW (2) 31 with an address translation operation.

While the configuration data management server 32 manages and issues the IP address belonging to the closed IP LAN (B) 300 to the remote terminal 1 in the present exemplary embodiment, it is possible to assign this function to another node (an address management server). In this case, the messages a8, a9 for obtaining the IP address and configuration data, shown in FIG. 4, are separated into the message for obtaining the VPN address and the message for obtaining private data (configuration data). Accordingly, the former message is sent to the address management server and the latter is sent to the configuration data management server through separate message communications.

While the technique has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the following claims.

1-31. (canceled)

32. A method, comprising:
performing an authentication between a communication terminal and a gateway via a first Internet protocol (IP) network according to a configuration method;
issuing configuration data and an IP address belonging to a second IP network from the gateway to the communication terminal, the second IP network being connected with the gateway.

33. The method according to claim 32, further comprising, establishing an encapsulating security payload tunnel between the communication terminal and the gateway based on the issued IP address.

34. The method according to claim 33, wherein the gateway obtains the configuration data and the IP address from a management server of the second IP network.

35. The method according to claim 33, wherein the gateway obtains the configuration data from a configuration data management server, and obtains the IP address from an IP address management server.

36. The method according to claim 33, wherein a pre-shared key is used in performing the authentication.

37. The method according to claim 33, wherein the first IP network is a public IP network.

38. The method according to claim 33, wherein the configuration data and the IP address are issued according to an Internet key security association and key management protocol (ISAKMP) configuration method.

39. A network system, comprising:
a gateway, connected with a second internet protocol (IP) network operable to issue configuration data and an IP address belonging to the second IP network; and
a communication terminal, coupled to the gateway via a first IP network, operable to perform an authentication with the gateway according to a configuration method, and to receive the issued configuration data and the issued IP address from the gateway after performing the authentication.

40. The network system according to claim 39, wherein
the communication terminal is operable to establish an encapsulating security payload tunnel with the gateway based on the issued IP address.

41. The network system according to claim 40, wherein
the gateway is operable to obtain the configuration data and the IP address from a management server of the second IP network.

42. The network system according to claim 40, wherein the gateway is operable to obtain the configuration data from a configuration data management server, and further operable to obtain the IP address from an IP address management server.

43. The network system according to claim 40, wherein the communication terminal is operable to perform the authentication by using a pre-shared key.

44. A net work system according to claim 40, wherein the first IP network is a public IP network.

45. A network system according to claim 40, wherein the gateway is operable to issue the configuration data and the IP address according to an Internet key security association and key management protocol (ISAKMP) configuration method.

46. A communication terminal, comprising:
a controller operable to perform an authentication with a gateway via a first IP network according to a configuration method;
a transceiver, operable to communicate with the controller, the transceiver further operable to receive configuration data and an IP address belonging to a second IP network from the gateway after the authentication.

47. The communication terminal according to claim 46, wherein the controller is further operable to establish an encapsulating security payload tunnel with the gateway based on the received IP address.

48. The communication terminal according to claim 47, wherein
the configuration data and the IP address are obtained by the gateway from a management server of the second IP network.

49. The communication terminal according to claim 47, wherein
the configuration data and the IP address are obtained by the gateway from a configuration data management server and an IP address management server, respectively.

50. The communication terminal to claim 47, wherein the controller is operable to perform the authentication by using a pre-shared key.

51. The communication terminal according to claim 47, wherein the first IP network is a public IP network.

52. The communication terminal according to claim 47, wherein the configuration data and the IP address are issued according to an Internet key security association and key management protocol (ISAKMP) configuration method.

53. A gateway, comprising:
a controller operable to perform an authentication with a communication terminal via a first IP network according to a configuration method;
a transceiver, coupled to the controller, operable to issue configuration data and an IP address belonging to a second IP network to the communication terminal.

54. The gateway according to claim 53, wherein the controller is operable to establish an encapsulating security payload tunnel with the communication terminal based on the issued IP address.

55. The gateway according to claim 54, wherein
the transceiver is operable to obtain the configuration data and the IP address belonging to the second IP network from a management server of the second IP network.

56. The gateway according to claim 54, wherein
the transceiver is operable to obtain the configuration data from a configuration data management server and further operable to obtain the IP address from an IP address management server.

57. The gateway according to claim 54, wherein the controller is operable to perform the authentication by using a pre-shared key.

58. The gateway according to claim 54, wherein the first IP network is a public IP network.

59. The gate way according to claim 54, wherein the transceiver is operable to issue the configuration data and the IP address according to an Internet key security association and key management protocol (ISAKMP) configuration method.

60. The method of claim 32, wherein the configuration method is Internet key security association and key management protocol (ISAKMP).

61. The network system of claim 39, wherein the configuration method is Internet key security association and key management protocol (ISAKMP).

62. The communication terminal of claim 46, wherein the configuration method is Internet key security association and key management protocol (ISAKMP).

63. The gateway of claim 53, wherein the configuration method is Internet key security association and key management protocol (ISAKMP).
